(19) United States
(12) Patent Application Publication
(10) Pub. No.: US 2013/0139399 A1
(43) Pub. Date: Jun. 6, 2013

(54) MEASURING FIXTURE

(71) Applicants: YUN-YU CHOU, Tu-Cheng (TW); KO-HUA CHEN, Tu-Cheng (TW)

(72) Inventors: YUN-YU CHOU, Tu-Cheng (TW); KO-HUA CHEN, Tu-Cheng (TW)

(21) Appl. No.: 13/647,498

(22) Filed: Oct. 9, 2012

(30) Foreign Application Priority Data
Dec. 6, 2011 (TW) 100144776

(51) Int. Cl. G01B 5/02

(52) U.S. Cl. 33/783

(57) ABSTRACT

A measuring fixture is used with a slide caliper for measuring dimensions of workpiece; the measuring fixture includes a first measuring portion and a second measuring portion. The first measuring portion defines a plurality of first measuring grooves thereon. The second measuring portion defines a plurality of second measuring grooves thereon corresponding to the plurality of first measuring grooves respectively. The measuring fixture defines a receiving portion thereon between the first and the second measuring portions. A pair of measuring jaws of the slide caliper are capable of sliding and receiving in a first measuring groove and a corresponding second measuring groove respectively to measure linear dimension or size of workpiece received in the receiving portion.

### BACKGROUND

1. Technical Field

The present disclosure relates to measuring fixtures, and more particularly to a measuring fixture used with a slide caliper.

2. Description of Related Art

Slide caliper is employed to measure dimensions or linear distances for various types of workpieces to monitor the quality of the workpieces. The workpieces may be, for example, plastic frames of backlight module. When a large number of plastic frames are fabricated, several types of key dimensions or sizes of the plastic frame should be tested. However, in use, the two measuring jaws of the slide caliper slip easily, thus making the measuring speed using the slide caliper to be relatively low.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a measuring fixture configured for a workpiece.

FIG. 2 is an isometric view of the measuring fixture of FIG. 1 with the workpiece being removed from the measuring fixture.

FIG. 3 is another isometric view of the measuring fixture of FIG. 2.

### DETAILED DESCRIPTION

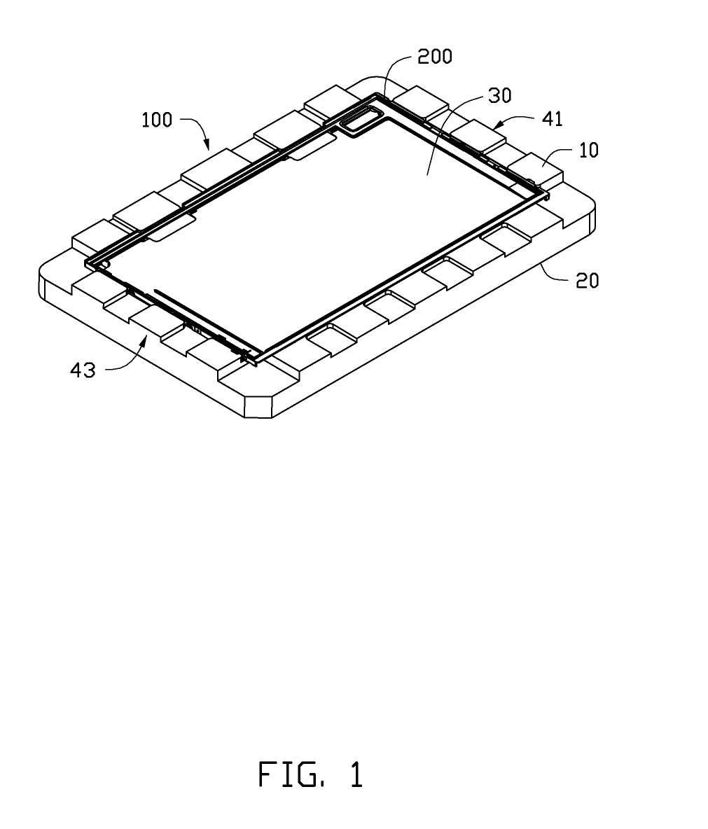

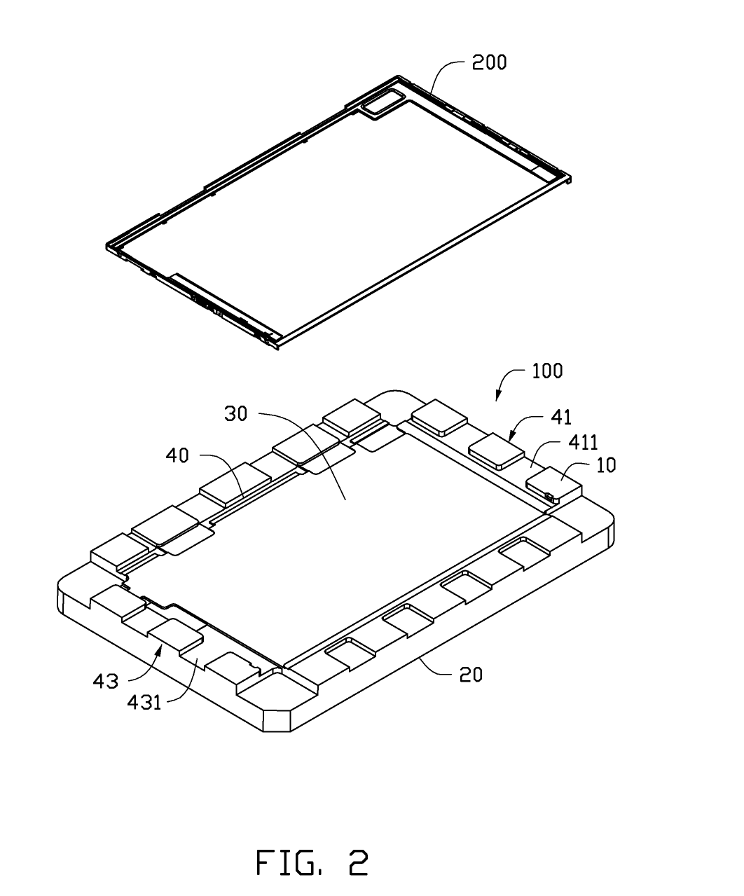

FIGS. 1 and 2 show an embodiment of a measuring fixture 100 for measuring a plastic frame 200, as an example of a workpiece, with a slide caliper (not shown). The measuring fixture 100 includes a top surface 10 and a bottom surface 20 opposite to the top surface 10. The measuring fixture 100 further defines a receiving portion 30 on the top surface 10 and includes a sidewall 40 surrounding the receiving portion 30. The sidewall 40 includes a first measuring portion 41 and a second measuring portion 43 opposite to the first measuring portion 41. A method of using the measuring fixture 100 for measuring a length distance of the plastic frame 200 is described as follow; the plastic frame 200 is first received in the receiving portion 30; two measuring jaws of the slide caliper are then placed to be located at the first measuring portion 41 and the second measuring portion 43 respectively, and the pair of measuring jaws are adjusted to clamp opposite sides of the plastic frame 200 to measure a particular dimension or size of the plastic frame 200. In the embodiment, the plastic frame 200 is a rectangular frame.

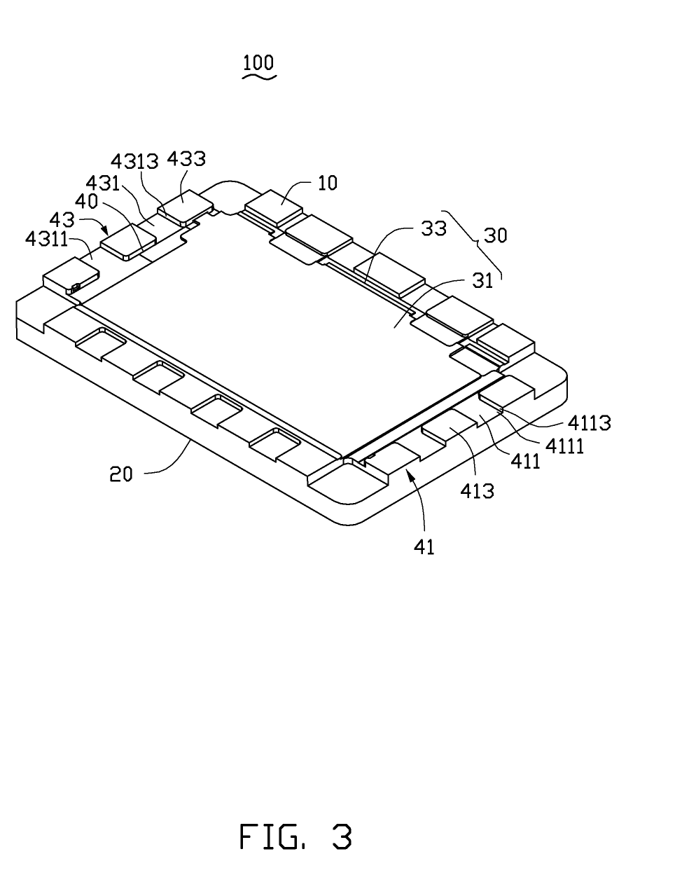

Also referring to FIG. 3, the measuring fixture 100 is in a shape of a rectangular block, the top surface 10 is parallel to the bottom surface 20. The receiving portion 30 is defined on a middle portion of the top surface 10. The receiving portion 30 includes a positioning protrusion 31 and defines a substantially rectangular receiving groove 33 thereon corresponding to the plastic frame 200 surrounding the positioning protrusion 31.

The sidewall 40 has a rectangular shape and is located at a periphery of the receiving portion 30. The first measuring portion 41 and the second measuring portion 43 are opposite to each other, and located at two ends of the measuring fixture 100. The first measuring portion 41 defines a plurality of first measuring grooves 411 and includes a plurality of first measuring blocks 413. The plurality of first measuring blocks 413 are spaced from each other uniformly. Each first measuring groove 411 is located between two adjacent first measuring blocks 413. The first measuring groove 411 defines a plurality of first bottom surfaces 4111 on the bottom of the plurality of first measuring grooves 411 respectively, and a pair of first resisting surfaces 4113 on opposite sides of each first measuring groove 411. In the embodiment, the first measuring groove 411 is a rectangular opening. Each first bottom surface 4111 is a plane, the plurality of bottom surfaces 4111 are coplanar with each other. The plurality of first resisting surfaces 4113 are perpendicular to the plurality of first bottom surfaces 4111 respectively.

The second measuring portion 43 is similar to the first measuring portion 41 in structure. The second measuring portion 43 defines a plurality of second measuring grooves 431 thereon corresponding to the plurality of first measuring grooves 411 of the first measuring portion 41, respectively. The second measuring portion 43 further includes a plurality of second measuring blocks 433 arranged corresponding to the plurality of first measuring blocks 413 respectively. The second measuring portion 43 defines a second bottom surface 4311 on the bottom of each second measuring groove 431, and a pair of second resisting surfaces 4313 on opposite ends of each second measuring groove 431. The plurality of second bottom surfaces 4311 are coplanar with the plurality of first bottom surfaces 4111. The plurality of second resisting surfaces 4313 are coplanar with the plurality of first resisting surfaces 4113, respectively.

Referring to FIG. 3, during the usage of the measuring fixture 100, the plastic frame 200 is placed in the receiving grooves 33 and surrounds the positioning protrusion 31. Sidewalls of the plastic frame 200 are higher than the first bottom surfaces 4111 and the second bottom surfaces 4311. The pair of measuring jaws of the slide caliper is received in one first measuring groove 411 and one corresponding second measuring groove 431 respectively. One measuring jaw of the slide caliper is placed at one of the first bottom surface 4111 and abuts against the corresponding first resisting surface 4113. The other measuring jaw of the slide caliper is located at one second bottom surface 4311 and abuts against one corresponding second resisting surface 4313. The pair of measuring jaws of the slide caliper are adjusted to move toward each other and clamps two ends of the plastic frame 200, thus the length of the plastic frame 200 is then measured. In order to obtain more accurate measurements of the dimensions of the plastic frame 200, the slide caliper may be positioned and taken measurements in different sets of the first measuring grooves 411 and the corresponding second measuring grooves 431, respectively, for several times, upon which an averaged measurement value based upon the plurality of length measurements of the plastic frames is then obtained.

The pair of measuring jaws are capable of leaning on a first resisting surface 4113 and the corresponding second resisting surface 4313 respectively when performing length measurements, so that the pair of measuring jaws does not slip. An averaged value of the plurality of length measurements of the plastic frame 200 can be obtained by configuring the pair of measuring jaws to be placed on the plurality of first measuring grooves 411 and the plurality of second measuring grooves 431 respectively for conducting length measurements on the plastic frame 200 for many times. The first resisting surface 4113 is coplanar with the corresponding second resisting surface 4313, thus the pair of measuring jaws is difficult to be skewed, the first bottom surfaces 4111 are coplanar with the second bottom surfaces 4311, thus the pair of measuring jaws are maintained at the same height as that of the plastic frame 200 to increase the precision of measurement.

The sidewall 40 may further includes a third measuring portion, and a fourth measuring portion arranged perpendicular to the first measuring portion 41 to measure a width of the plastic frame 200. The pair of first resisting surface 4113 arranged on opposite sides of each first measuring groove 411 may have a distance equal to a thickness of the measuring jaw. When the shape of the plastic frame 200 is configured in another shape, the measuring fixture 100 may be changed accordingly.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A measuring fixture for measuring a workpiece with a slide caliper having a pair of measuring jaws, comprising:
a first measuring portion defining a plurality of first measuring grooves thereon; and;
a second measuring portion defining a plurality of second measuring grooves thereon corresponding to the plurality of first measuring grooves respectively, wherein a receiving portion is defined in the measuring fixture thereon between the first and the second measuring portions, the pair of measuring jaws of the slide caliper are capable of slidably received in a first measuring groove and a corresponding second measuring groove respectively to measure a dimension of the workpiece received in the receiving portion.

2. The measuring fixture of claim 1, wherein the measuring fixture comprises a top surface and a bottom surface opposite to the top surface, and the receiving portion is defined on a middle portion of the top surface of the measuring fixture.

3. The measuring fixture of claim 2, further comprising a sidewall surrounding the receiving portion, the sidewall comprising the first and the second measuring portions, wherein the first measuring portion is opposite to the second measuring portion, the first and the second measuring portions are located at two ends of the measuring fixture.

4. The measuring fixture of claim 3, wherein the receiving portion comprises a positioning protrusion and defines a receiving groove thereon, the receiving groove surrounds the positioning protrusion.

5. The measuring fixture of claim 1, wherein the first measuring portion comprises a plurality of first measuring blocks, the plurality of first measuring blocks are spaced from each other uniformly, each first measuring groove is located between two adjacent first measuring blocks, the second measuring portion comprises a plurality of second measuring blocks arranged corresponding to the plurality of first measuring blocks, the plurality of second measuring blocks are spaced from each other uniformly, each second measuring groove is located between two adjacent second measuring blocks.

6. The measuring fixture of claim 5, wherein the first measuring portion defines a plurality of first bottom surfaces on the bottom of the plurality of first measuring grooves respectively, and a pair of first resisting surfaces on opposite sides of each first measuring groove, each first bottom surface is a plane, the plurality of first bottom surfaces are coplanar with each other, the plurality of first resisting surfaces are perpendicular to the plurality of first bottom surfaces respectively.

7. The measuring fixture of claim 6, wherein the second measuring portion defines a second bottom surface on the bottom of each second measuring groove, and a pair of second resisting surfaces on opposite ends of each second measuring groove, the plurality of second bottom surfaces are coplanar with the plurality of first bottom surface, the plurality of second resisting surfaces are coplanar with the plurality of first resisting surfaces respectively.

8. A measuring fixture for measuring workpiece with a slide caliper, comprising:
a top surface; and
a bottom surface opposite to the top surface;
wherein the measuring fixture defines a receiving portion on the top surface, and further comprises a first measuring portion and a second measuring portion surrounding the receiving portion, the first measuring portion defines a plurality of first measuring grooves thereon, the second measuring portion defines a plurality of second measuring grooves thereon arranged corresponding to the plurality of first measuring grooves respectively, a pair of measuring jaws of the slide caliper are capable of sliding in a first measuring groove and a corresponding second measuring groove respectively to measure a dimension of workpiece received in the receiving portion.

9. The measuring fixture of claim 8, wherein the receiving portion is defined on a middle portion of the top surface, the measuring fixture further comprises a sidewall surrounding the receiving portion, the first and the second measuring portions are belonging to the sidewall, the first measuring portion is located opposite to the second measuring portion, the first measuring portion and the second measuring portion are located at two ends of the measuring fixture.

10. The measuring fixture of claim 9, wherein the receiving portion comprises a positioning protrusion and defines a receiving groove thereon, and the receiving groove surrounds the positioning protrusion.

11. The measuring fixture of claim 8, wherein the first measuring portion comprises a plurality of first measuring blocks, the plurality of first measuring blocks are spaced from each other uniformly, each first measuring groove is located between two adjacent first measuring blocks, the second measuring portion comprises a plurality of second measuring blocks corresponding to the plurality of first measuring blocks, the plurality of second measuring blocks are spaced from each other uniformly, each second measuring groove is located between two adjacent second measuring blocks.

12. The measuring fixture of claim 11, wherein the first measuring portion defines a plurality of first bottom surfaces on the bottom of the plurality of first measuring grooves respectively, and a pair of first resisting surfaces on opposite sides of each first measuring groove, each first bottom surface is a plane, the plurality of first bottom surfaces are coplanar with each other, the plurality of first resisting surfaces are perpendicular to the plurality of first bottom surfaces respectively.

13. The measuring fixture of claim 12, wherein the second measuring portion defines a second bottom surface on the bottom of each second measuring groove, and a pair of second resisting surfaces on opposite ends of each second measuring groove, the plurality of second bottom surfaces are coplanar with the plurality of first bottom surfaces, the plurality of second resisting surfaces are coplanar with the plurality of first resisting surfaces respectively.
